(19) United States
(12) Patent Application Publication
(10) Pub. No.: US 2009/0161373 A1
(43) Pub. Date: Jun. 25, 2009

(54) Board structure with an illumination light source

(75) Inventors: Kuo-Hsin Teng, Taipei (TW); Hon-Lun Chen, Taipei (TW); Wen-He Lin, Taipei (TW)

Correspondence Address: REED SMITH LLP, 3110 Fairview Park Drive, Suite 1400, Falls Church, VA, 22042, US

(73) Assignee: PRODISC TECHNOLOGY INC.

(21) Appl. No.: 12/068,415

(22) Filed: Feb. 6, 2008

(30) Foreign Application Priority Data
Dec. 24, 2007 (TW) 096221910

(51) Int. Cl. F21V 19/00; F27D 21/02

(52) U.S. Cl. 362/382

(57) ABSTRACT

A board structure with an illumination light source comprises a board and a light source module, wherein the board has a first surface and an accommodating space, and the light source module is disposed in the accommodating space. By installing the light source module in the accommodating space and having light rays emitted from the light source module project upwards, an object placed on the board and adjacent to the accommodating space can be illuminated with the light rays focused and projected thereon.

### BACKGROUND OF THE INVENTION

1. Technical Field

The present invention relates to a board structure with an illumination light source, and more particularly, to a board structure with an illumination light source that is applicable to a game table.

2. Description of Related Art

While playing mahjong, bridge and like games, the players usually group around a table and are each distributed with a certain number of tiles or cards before the game is played. The players have to keep the tiles or cards upright, with patterns thereon facing the players, so that each of the players can clearly see the patterns on the tiles or cards he or she has on hand while preventing the other players from seeing them.

Such games are generally played indoors where ceiling lamps are used as a light source of indoor illumination. In this case, light is cast from a relative high location for illumination, so that patterns on the tiles or cards in a player's hand are lit from the back and a shadow is formed, making the patterns obscure to the player. In order to see the patterns clearly, the angles at which the tiles or cards are held must be adjusted for the patterns to be lit up. But this also gives the other players a chance to glance at those patterns. Therefore, it is necessary to improve the way of illumination so that the players can easily distinguish the patterns on the tiles or cards.

Taiwan Patent Application No. 87221278 discloses an improved mahjong table structure, wherein a mahjong table is installed on a perimeter thereof with an independent table frame that can be lifted up. The table frame is provided with a spring at a side edge thereof so that the table frame is combined with a tabletop of the table and allowed to be lifted up and then returned elastically to its closed position. In addition, the table frame is formed with a special slanted and rounded surface thereof while a fluorescent lamp is installed therein. A plurality of through holes on sides of the table frame allow light emitted from the fluorescent lamp to project through. With this design, a mahjong mat or paper can be conveniently and rapidly put in place or replaced, and light emitted from the fluorescent lamp installed in the table frame can pass through the through holes and project on the tiles for a player to easily see the patterns thereon. However, a light-emitting angle is limited by a thickness of the table frame, so that only tiles adjacent to the tabletop, rather than all the tiles, are illuminated.

U.S. Pat. No. 6,109,758 discloses a brightness enhancing strip for game tables. The brightness enhancing strip has a plurality of light reflecting facets and can be lined along rims of a game table. When one or more light sources located above the game table are used to illuminate a tabletop, some of light rays reaching the strips are reflected towards a central portion of the tabletop. Such strips are useful for enhancing brightness of the game table and of game pieces that are placed facing the strips and away from the table rim. However, while the brightness enhancing strips can be used to reflect light and thus light up the game pieces, such effects cannot be achieved when brightness of the indoor light sources is inadequate.

### SUMMARY OF THE INVENTION

The present invention discloses a board structure with an illumination light source, wherein a light source module is disposed in an accommodating space of a board, so that light emitted from the light source module directly illuminates an object placed on the board and adjacent to the accommodating space. The board structure with the illumination light source can provide illumination effects even when brightness of indoor light sources is insufficient.

To achieve this end, the present invention provides a board structure with an illumination light source which comprises a board having a first surface and at least one accommodating space; and a light source module disposed in the accommodating space.

In this board structure with the illumination light source, the board can be a square board and have four accommodating spaces, wherein each of the accommodating spaces can be perpendicular to an adjacent said accommodating space and parallel to an opposite said accommodating space. The accommodating space can be a hollow space or, alternatively, the accommodating space can have a second surface parallel to the first surface or, alternatively, the second surface can be an inclined surface and the light source module is disposed thereon.

In the above-mentioned board structure with the illumination light source, the light source module can be a light-emitting diode light source module or a light tube.

The above-mentioned board structure with the illumination light source can further comprise a light-transmitting element disposed on a top portion of the accommodating space, wherein the light-transmitting element has a third surface that can be joined with the first surface to form a planar surface. The accommodating space can further comprise a support portion for supporting the light-transmitting element. The light-transmitting element can be an acrylic, a transparent glass, a ground glass or a diffuser plate.

The present invention can be implemented to at least provide the following advantageous effects:

1. The light source module is disposed directly in the accommodating space so that the board itself serves the function of illumination;

2. With the light source module in the accommodating space, light is projected directly onto an object on the board to illuminate the object;

3. By placing the light-transmitting element on the top portion of the accommodating space, the board is provided with a smooth surface for convenient use; and

4. Using a light-emitting diode light source module as the light source module helps saving electricity.

The features and advantages of the present invention are disclosed in detail in the following description so that a person skilled in the art can understand the technical content of the present invention and put it into practice. A person skilled in the art can readily comprehend the objectives and advantages of the present invention by referring to the content disclosed herein, the appended Claims and the accompanying drawings.

### BRIEF DESCRIPTION OF THE DRAWINGS

FIG. 1 is a schematic view of a board structure with an illumination light source according to the present invention.

FIG. 2A is a cross-sectional view taken along a line A-A in FIG. 1 showing a first embodiment of the board structure with the illumination light source according to the present invention.

FIG. 2B is a cross-sectional view taken along the line A-A in FIG. 1 showing a second embodiment of the board structure with the illumination light source according to the present invention.

FIG. 3 is a cross-sectional view taken along the line A-A in FIG. 1 showing a third embodiment of the board structure with the illumination light source according to the present invention.

FIG. 4 is a cross-sectional view taken along the line A-A in FIG. 1 showing a fourth embodiment of the board structure with the illumination light source according to the present invention.

### DETAILED DESCRIPTION OF THE PREFERRED EMBODIMENT

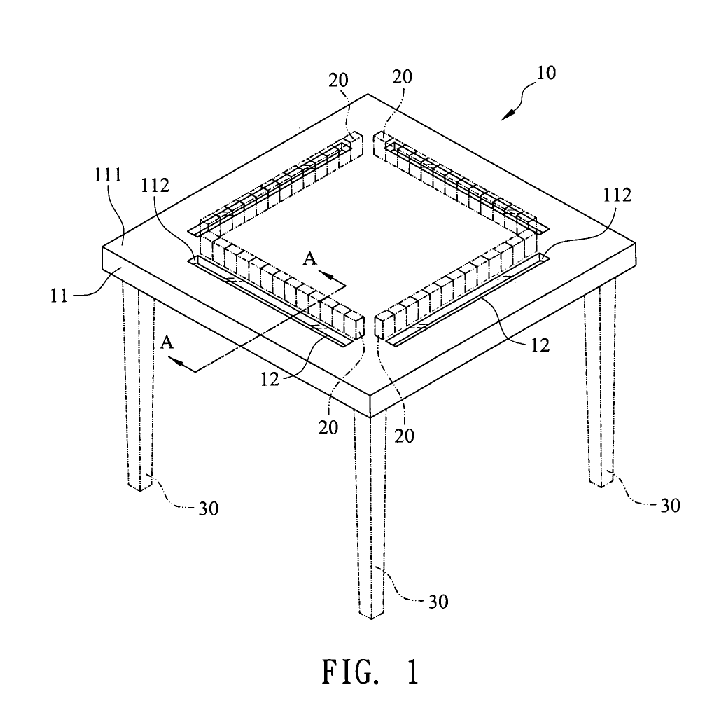

In the embodiment shown in FIG. 1, the board structure 10 with the illumination light source comprises a board 11 and a light source module 12.

The board 11 has a first surface 111 and at least one accommodating space 112. The first surface 111 is a top surface of the board 11 for supporting an object 20 thereon. For example, mahjong tiles can be placed on the first surface 111. As shown in FIG. 1, the board 11 can be a square board and have four accommodating spaces 112, wherein the accommodating spaces are arranged along four sides of the square board to form a rectangle, and each of the accommodating spaces is perpendicular to an adjacent said accommodating space and parallel to an opposite said accommodating space. Alternatively, the four accommodating spaces 112 can be joined to form an interconnected space. The board 11 can be used as a tabletop of a game table and be combined with table legs 30 to form a game table with an illumination light source.

The light source module 12 can be a light-emitting diode light source module or a light tube. The light source module 12 is disposed in the accommodating space 112, and light emitted from the light source module 12 is projected from the accommodating space 112 towards the first surface 111 of the board 11, so that light emitted from the light source module 12 is directly projected onto the object 20 located on the board 11 and adjacent to the accommodating space 112, thereby illuminating the object 20 with sufficient light.

Using a light-emitting diode light source module as the light source module 12 not only serves the purpose of energy saving, but also prevents ultra-violet rays from being generated and harming human bodies. Furthermore, a light-emitting diode light source module is a cold light source, so that light rays emitted therefrom do not generate much heat. Therefore, when the board structure 10 with an illumination light source is used in summer, the user will not feel uncomfortably hot.

The above-mentioned light-emitting diode light source module can be a white light-emitting diode light source module; a light-emitting diode light source module consisting of red light-emitting diodes, green light-emitting diodes and blue light-emitting diodes; or a light-emitting diode light source module consisting of other color light-emitting diodes. A user can adjust a color temperature or brightness of the light-emitting diode light source module to obtain the most comfortable color temperature or brightness for the user.

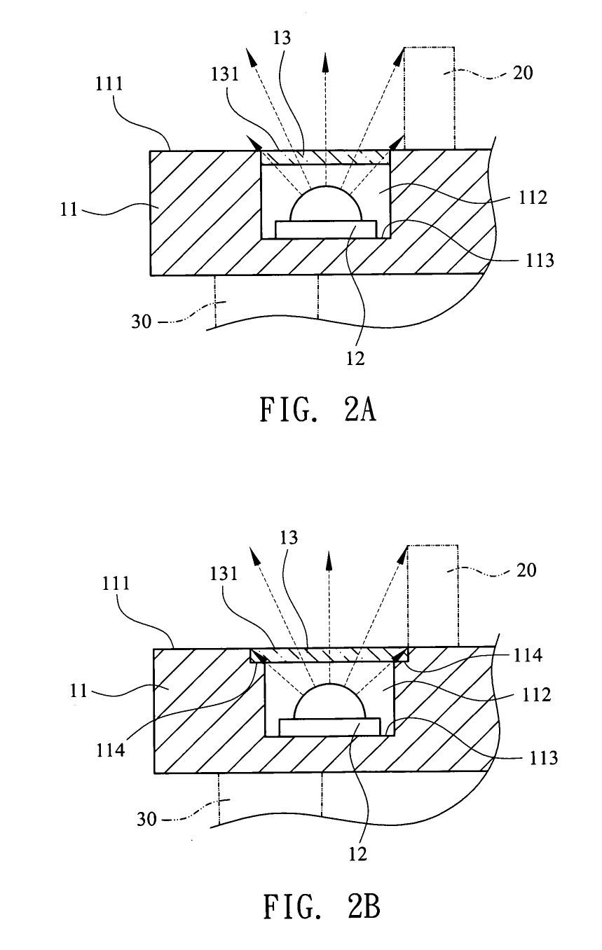

As shown in FIGS. 2A, 2B, 3 and 4, the accommodating space 112 can have a second surface 113 and the light source module 12 is located on the second surface 113. As shown in FIG. 2A, the second surface 113 can be parallel to the first surface 111. When the light source module 12 is disposed on the second surface 113 of the accommodating space 112, light rays emitted from the light source module 12 are projected towards the first surface 111, so that part of the light rays illuminate the object 20 (such as a mahjong tile) on the first surface 111 and provide the object 20 with sufficient brightness. Thus, a user watching the object 20 for a long time will not feel tired because of inadequate brightness.

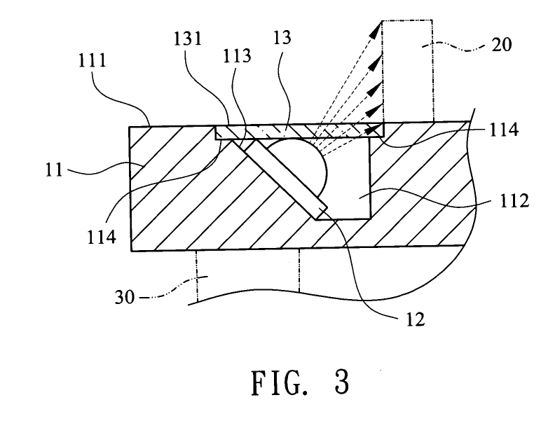

As shown in FIG. 3, the second surface 113 can also be an inclined surface. When the light source module 12 is disposed on such a second surface 113, given that the second surface 113 is an inclined surface and that a front light of the light source module 12 has the greatest light intensity, light rays with the greatest light intensity emitted from the light source module 12 can directly illuminate the object 20 on the first surface 111, providing the object 20 with sufficient brightness.

As shown in FIGS. 2A, 2B and 3, the board structure 10 with an illumination light source according to these embodiments of the present invention can further comprise a light-transmitting element 13. The light-transmitting element 13 can be an acrylic, a transparent glass, a ground glass, a diffuser plate or other similar light-transmitting elements.

The light-transmitting element 13 is installed on a top portion of the accommodating space 112 and has a third surface 131. The third surface 131 of the light-transmitting element 13 is joined with the first surface 111 of the board 11 to form a common planar surface, so that the top surface of the board 11 is a smooth surface without protrusions that may hinder the playing of a game. In addition, the light-transmitting element 13 also serves to prevent dust or the object 20 (such as a mahjong tile) from falling into the accommodating space 112.

As shown in FIGS. 2B and 3, the accommodating space 112 can be further provided with a support portion 114 for supporting the light-transmitting element 13. In other words, the light-transmitting element 13 can be placed directly on the support portion 114. When the light source module 12 needs replacing or maintenance, a user can also directly take out the light-transmitting element 13 for replacing the light source module 12 or doing maintenance work thereto.

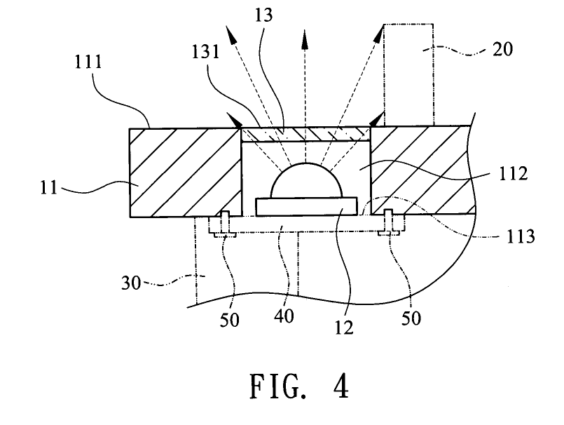

As shown in FIG. 4, the accommodating space 112 can also be a hollow space. The light source module 12 can be combined with a base plate 40 in advance, and then the base plate 40 combined with the light source module 12 is attached to a lower portion of the board 11 with screws 50, thereby securing the light source module 12 in place. When the light source module 12 requires replacing or maintenance, the replacing or maintenance work can be performed from below the board 11. Furthermore, the top portion of the accommodating space 112 can also be equipped with the light-transmitting element 13 for preventing dust or the object 20 (such as a mahjong tile) from falling into the accommodating space 112.

It should be noted that the above-mentioned embodiments are described to explain the features of the present invention so that a person skilled in the art can understand the content of the present invention and put it into practice, and these embodiments are not intended to limit the scope of the present invention. Therefore, all equivalent modifications or alterations which do not depart from the spirit of the present invention are encompassed by the appended Claims.

What is claimed is:

1. A board structure with an illumination light source, comprising:
a board having a first surface and at least one accommodating space; and
a light source module disposed in the accommodating space.

2. The board structure as claimed in claim 1, wherein the board is a square board.

3. The board structure as claimed in claim 1, wherein the board is a square board and has four said accommodating spaces, in which each of the accommodating spaces is perpendicular to an adjacent said accommodating space and parallel to an opposite said accommodating space.

4. The board structure as claimed in claim 1, wherein the accommodating space is a hollow space.

5. The board structure as claimed in claim 1, wherein the accommodating space has a second surface parallel to the first surface, and the light source module is disposed on the second surface.

6. The board structure as claimed in claim 1, wherein the accommodating space has a second surface formed as an inclined surface, and the light source module is disposed on the second surface.

7. The board structure as claimed in claim 1, wherein the light source module is a light-emitting diode light source module.

8. The board structure as claimed in claim 1, wherein the light source module is a light tube.

9. The board structure as claimed in claim 1, further comprising a light-transmitting element disposed on a top portion of the accommodating space, wherein the light-transmitting element has a third surface, and the third surface is joined with the first surface to form a planar surface.

10. The board structure as claimed in claim 9, wherein the accommodating space further comprises a support portion for supporting the light-transmitting element.

11. The board structure as claimed in claim 9, wherein the light-transmitting element is an acrylic, a transparent glass, a ground glass or a diffuser plate.
